(19) United States
(12) Patent Application Publication
(10) Pub. No.: US 2007/0029737 A1
(43) Pub. Date: Feb. 8, 2007

(54) Replaceable magneto-fluidic seal cartridge and method for increasing the life and reliability of same

(75) Inventors: Yuri O. Mikhalev, Ivanovo (RU); Sergei G. Lysenkov, Ivanovo (RU)

Correspondence Address: BARDMESSER LAW GROUP, P.C., 910 17TH STREET, N.W., SUITE 800, WASHINGTON, DC, 20006, US

(73) Assignee: Ferrolabs, Inc., Dulles, VA (US)

(21) Appl. No.: 11/198,353

(22) Filed: Aug. 8, 2005

(51) Int. Cl. F16J 15/43

(52) U.S. Cl. 277/410

(57) ABSTRACT

A removable cartridge includes a permanent magnet, a pole piece, a shaft sleeve and a magnetic fluid between the pole piece and the shaft sleeve and forming a magneto-fluidic seal by directing a magnetic field from the permanent magnet through the magnetic fluid. The magnetic field in the magnetic fluid is reduced when the cartridge is stored to reduce the aging process of the magnetic fluid either by diverting the magnetic field, or by saturating magnetic flux from the magnet through a reduced with of the shaft sleeve.

### FIELD OF THE INVENTION

The present invention relates generally to magneto-fluidic seals and to a method for increasing the life and reliability of a magneto-fluidic seal.

### BACKGROUND OF THE INVENTION

When a magnetic field is not present, a magnetic fluid, or ferrofluid, functions like a typical fluid, for example, taking the shape of a container in which it is stored. However when subjected to a magnetic field, the magnetic particles within the fluid align with the magnetic flux lines provided by an associated magnet. Magneto-fluidic seals, utilizing a magnetic fluid, are particularly useful for forming seals around shafts, for example rotating shafts such as a stirring shaft for a reactor or bioreactor, or a power delivery shaft. These magneto-fluidic seals are particularly useful for forming a hermetic environment for the exclusion of contaminants and preventing escape of biological matter from an enclosed space into the environment.

Conventional magneto-fluidic seals for shafts are formed between a pole piece and a sleeve affixed to the shaft. The pole piece includes a annular-shaped magnet defining north and south polarities of the pole piece. The pole piece and the sleeve are separated by a gap. Magnetic fluid fills the gap, forming a hermetic seal between the pole piece and the sleeve.

However, the installation and maintenance of a magneto-fluidic seal often requires a high level of technical training, and inexperienced technicians can cause an ineffective seal, contamination of a reactor or leaking of the magnetic fluid, if improperly installed or improperly maintained. For example, conventional magneto-fluidic seals are formed along with the shaft, such that any maintenance to the shaft also requires disassembly of the magneto-fluidic seal by a technician skilled in working with magnetic fluids. Also, disassembly, replacement or repair of parts, reassembly and installation of the magneto-fluidic seal must often be performed in the field without the assistance of technicians trained in magnetic fluids. An example of a simple repair that becomes labor-and skill-intensive when performed in the filed is the addition of magnetic fluid to the gap between the pole piece and the shaft sleeve.

The magnetic fluid generally includes a suspension of dispersed magnetic particles coated with an anti-aggregation agent that forms a colloid. The magnetic fluid wears out when high magnetic fields are applied to the magnetic fluid over a long period of time due to clumping of the magnetic particles and loss of homogeneity, which decreases the reliability of the magneto-fluidic seal.

Thus, what is needed is a convenient way to install and maintain a magneto-fluidic seal and a way to increase the reliability by slowing down the aging process of a magnetic fluid.

### BRIEF SUMMARY OF THE INVENTION

In one embodiment, a magneto-fluidic seal cartridge includes an annular shaft sleeve, an annular pole piece surrounding the shaft sleeve, an annular magnet conducting a magnetic field to the pole piece, a magnetic fluid in a gap between the pole piece and the shaft sleeve, and a removable ring partially diverting a magnetic flux therethrough. A magnetic field is concentrated through the magnetic fluid upon removal of the removable ring. The cartridge lasts longer and the magnetic fluid ages more slowly since it is exposed to a lower magnitude magnetic field during storage.

Another embodiment features a magneto-fluidic seal cartridge, including an annular pole piece having an interior and exterior surface, an annular magnet generating a magnetic field in the pole piece, an annular shaft sleeve within the interior surface of the pole piece, and a magnetic fluid in a gap formed between the pole piece and the shaft sleeve. The shaft sleeve has an exterior surface, an interior surface and a portion of reduced width between the interior surface and the exterior surface where a magnetic flux from the magnet saturates.

Another embodiment features a method for increasing reliability of a magneto-fluidic seal that includes assembling a magneto-fluidic seal cartridge by positioning a magnetic fluid within a gap between a shaft sleeve and a pole piece; and reducing a magnetic field provided by the magnet in the magnetic fluid cartridge during storage by diverting a portion of the magnetic field.

Another embodiment features a method for increasing reliability of a magneto-fluidic seal that includes assembling a magneto-fluidic seal cartridge by positioning a magnetic fluid within a gap between a shaft sleeve and a pole piece; and reducing a magnetic field provided by the magnet in the magnetic fluid cartridge during storage by saturating magnetic flux directed through a portion of reduced width of the shaft sleeve.

It is to be understood that both the foregoing general description and the following detailed description are exemplary and explanatory and are intended to provide further explanation of the invention as claimed.

### BRIEF DESCRIPTION OF THE DRAWINGS/FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 is partial sectional view of one embodiment of a magneto-fluidic seal cartridge.

FIG. 2 is a partial sectional view of the magnetic fluid cartridge of FIG. 1 mounted on a shaft.

FIG. 3 is a sectional perspective view of an alternative magneto-fluidic seal cartridge.

FIG. 4 is a sectional perspective view of an alternative magneto-fluidic seal cartridge of mounted on a shaft.

FIG. 5 is a partial sectional view of an alternative magneto-fluidic seal cartridge.

FIG. 6 is a partial sectional view of an alternative magneto-fluidic seal cartridge.

FIG. 7 is a sectional perspective view of the magneto-fluidic seal cartridge of FIG. 6.

FIG. 8 is a partial sectional view of the magnetic fluid cartridge of FIG. 7 mounted on a shaft.

FIG. 9 is a partial sectional view of another exemplary cartridge embodiment.

FIG. 10 is a partial sectional view of another exemplary cartridge embodiment.

### DETAILED DESCRIPTION OF THE INVENTION

Reference will now be made in detail to embodiments of the present invention, examples of which are illustrated in the accompanying drawings.

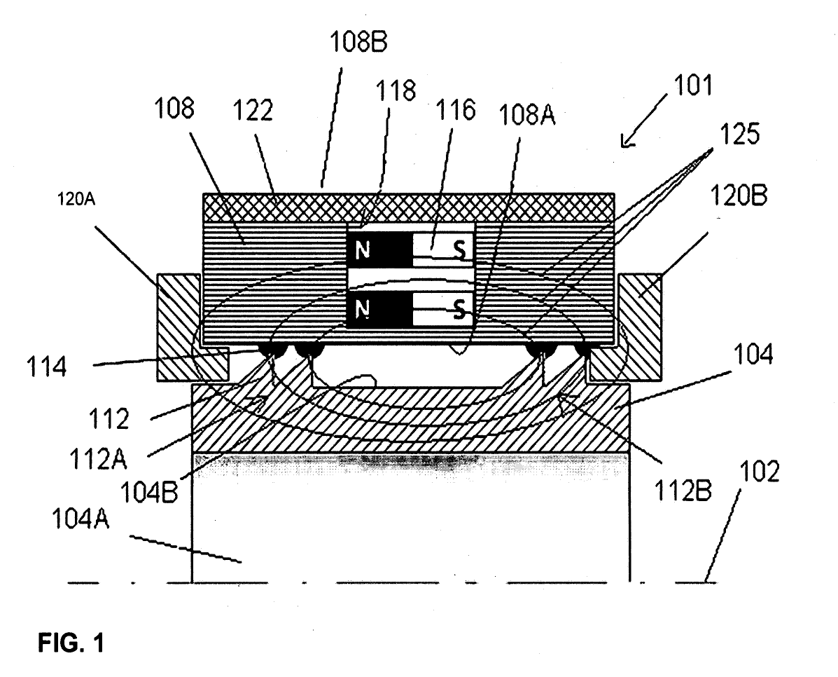

FIG. 1 illustrates a magnetic fluid cartridge 101. Cartridge 101 is annular-shaped, such that only one half of the cross-section, or one quarter, of cartridge 101 is provided in FIG. 1. The dashed line 102 is the axis of annular-shaped cartridge 101. A mirror image of FIG. 1 provides the opposite half of the cross section of cartridge 101 illustrated in FIG. 1.

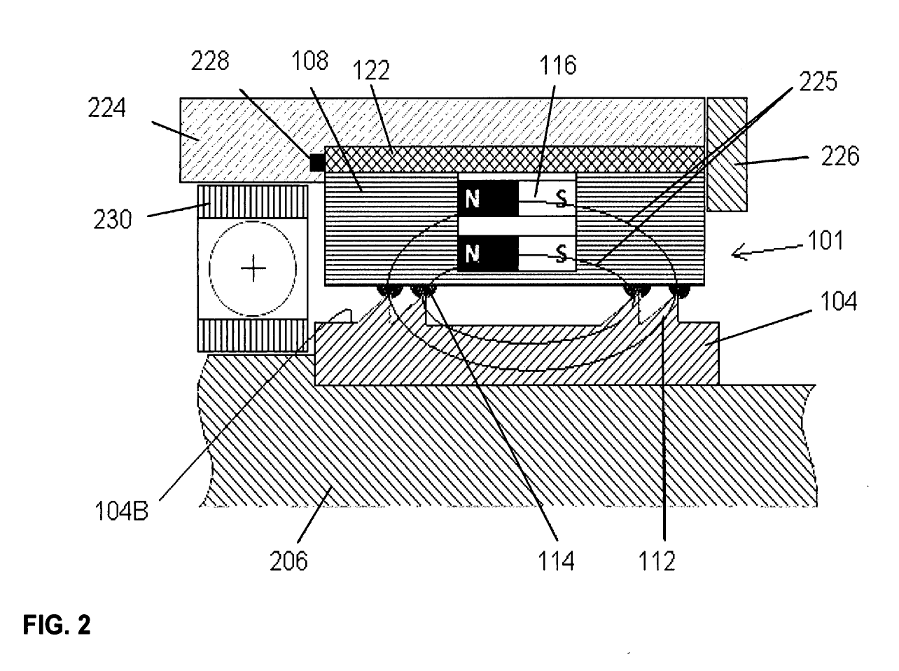

Cartridge 101 includes an annular-shaped shaft sleeve 104. Shaft sleeve 104 includes an interior surface 104A and an exterior surface 104B. Interior surface 104A of shaft sleeve 104 defines a hollow channel for slidably receiving a shaft 206, such as a rotating shaft, as illustrated in FIG. 2. Returning to FIG. 1, cartridge 101 further includes a pole piece 108. Pole piece 108 is also annular shaped and has an interior surface 108A and an exterior surface 108B. Pole piece 108 surrounds shaft sleeve 104 such that interior surface 108A of pole pieces 108 is close to, but not contacting, exterior surface 104B of shaft sleeve 104. As such a gap 110 is formed between pole piece 108 and shaft sleeve 104. A magnetic fluid 114 is placed between pole piece 108 and shaft sleeve 104.

In FIGS. 1 and 2, exterior surface 104B of shaft sleeve 104 includes a plurality of projections (concentrators) 112 protruding therefrom into gap 110. In FIG. 1, a first set of projections 112A are spaced away from a second set of projections 112B. First and second sets of projections 112A and 112B are longitudinally spaced on an opposite side of magnets 116, with first set 112A adjacent north poles of magnets 116 and second set 112B adjacent south poles of magnets 116. Magnetic flux lines, shown in FIGS. 1 and 2 are drawn from the north poles of magnets 116, through first set 112A of projections 112, through shaft sleeve 104, through second set 112B of projections 112B and to south poles of magnets 116. Although two projections 112 are shown in each of the first and second sets 112A, 112B, first and second sets 112A, 112B can have more or fewer projections 112. With the addition of projections, a better magneto-fluidic seal is formed between shaft sleeve 104 and pole piece 108.

In an alternative embodiment, projections 112 can extend from interior surface 108A of pole piece 108 into gap 110 towards shaft sleeve 104. Although projections 112 are illustrated as pointed, projections 112 can take on another shape. Preferably, however, projections 112 narrow somewhat as they extend towards pole piece 108 to concentrate the magnetic field passing through the magnetic fluid 114. In the presence of one or more magnet 116 as illustrated, magnetic fluid 114 forms a fluid seal between projections 112 and interior surface 108A of pole piece 108.

Two annular-shaped magnets 116 are shown in FIG. 1 positioned in a annular channel 118 formed in exterior surface 108B of pole piece 108. Typically, each such magnet 116 is formed of two or more segments (e.g., half-ring segments, quarter-ring segments, etc., or magnets of other relatively simple shapes, e.g., cylinders, flat plates, etc.), that are assembled into an annular shape. Although two magnets are illustrated in the figures, one or more magnets 116 can be suitable for the particular application of the cartridge 101. If more than one magnet 116 is present, as shown, like poles are aligned in the same direction, as shown. Magnets 116 contact pole piece 108, which is made of magnetically conductive material, so as to provide polar qualities to pole piece 108. In alternate embodiments, magnets 116 can be positioned in other locations, for example, adjacent exterior surface 108B of pole piece 108 or within or on a surface of shaft sleeve 104.

Cartridge 101 also includes at least one, and usually two removable rings 120A, 120B on either side of pole piece 108 contacting a side of pole piece 108 and exterior surface 104B of shaft sleeve 104. Rings 120A, 120B center the shaft sleeve 104 with respect to the pole piece 108 in order that gap 110 remains even. Also, rings 120A, 120B can be removed for maintenance of the magneto-fluidic seal, for example, replacing or adding magnetic fluid to gap 110. Additionally, cartridge 101 includes an annular-shaped shell 122 surrounding pole piece 108. In FIGS. 1 and 2, shell 122 is preferably made from a non-magnetic conductive material, such as a plastic or ceramic material, or stainless steel.

Cartridge 101 has an advantage in that it is supplied to the end user in an assembled form. Cartridge 101 is replaceable, such that any maintenance required for the magneto-fluidic seal can be performed by a qualified personnel not in the field, but rather in a maintenance facility.

When being stored, i.e., when not providing a seal for a shaft, only a small magnetic field is necessary to prevent magnetic fluid from leaking from between shaft sleeve 104 and pole piece 108, for example due to gravity and other forces acting on the cartridge 101 during transportation or storage. When being stored, the pressure drop across the magnetic fluid is zero. Thus, only about 5-10% of the nominal magnetic field that is required to maintain the magnetic seal across a critical pressure drop (i.e., the maximum pressure before failure of the magneto-fluidic seal during operation) is needed to hold magnetic fluid 114 in place when stored. Thus, reducing the magnetic field through magnetic fluid 114 will reduce the aging process of the magnetic fluid 114, prolong the life of the cartridge 101, and increase the reliability of the magneto-fluidic seal.

FIG. 1 and 2 also illustrate the magnetic flux lines 125 associated with cartridge 101 when at-rest or when being stored and not in use, as shown in FIG. 1, and when slidably positioned on a shaft (which can be made of magnetically conducting or non-conducting material), as shown in FIG. 2. As shown in FIG. 1, removable rings 120A, 120B transmit some of the magnetic flux 125 from pole piece 108 directly to shaft sleeve 104. Preferably, rings 120A, 120B are dimensioned and made of appropriate material sufficient to reduce the intensity of the magnetic field in magnetic fluid 114. As such, when being stored or not in use, the magnetic flux 125 through magnetic fluid 114 is reduced, prolonging the life of the seal formed by the magnetic fluid 114. This reduced magnetic flux 125 is sufficient to maintain the positioning of the magnetic fluid and thus the seal along the projections 112 of shaft sleeve 104, but can not be sufficient to maintain the seal when sleeve shaft 104, for example rotates along with a rotating shaft 206.

Thus, when in an operating position, as illustrated in FIG. 2, it is desirable to have the full magnetic flux 225 from magnets 116 directed through magnetic fluid 114. FIG. 2 illustrates that cartridge 101 is slidably positioned within a casing 224 and held in place with a lid 226. Shaft sleeve 104 has been slid into place along shaft 206 and affixed thereto, for example by a fastener or the like. As illustrated in FIG. 2, removable rings 120A, 120B are removed before cartridge 101 is positioned and affixed around shaft 206. As such, the magnetic flux from magnets 116 is concentrated and directed through magnetic fluid 114. Preferably, one removable ring 120B remains while positioning cartridge between casing 224 and shaft 206 (not shown) to maintain the coaxial relationship between shaft sleeve 104 and pole piece 108. The removable ring 120B is then replaced by lid 226 when cartridge 101 is properly positioned, as shown in FIG. 2. A conventional hermetic seal 228, such as an O-ring, can be positioned to ensure a good fit between cartridge 101 and casing 224. Also, cartridge 101 can be positioned adjacent a conventional bearing 230, such as a ball bearing or a roller bearing, used to hold and stabilize shaft 206 in position with respect to casing 224.

Casing 224 can either be a magnetically conductive material or not. If casing 224 is not a magnetically conductive material, shell 122 of the cartridge 101 can be removed before installing cartridge 101 on a shaft 206. However, if casing 224 is made of a magnetically conductive material, shell 122 is necessary for insulating the magnetic flux 225 from being diverted towards casing 224 rather than towards the magnetic fluid 114.

A cartridge, such as cartridge 101 described above, provides an advantage in that it is easy for an unskilled technician to install and remove during routine maintenance of shaft 206, since the magnetic fluid 114 is already provided in a contained environment both when stored and when in use. Additionally, if the effectiveness of the magneto-fluidic seal begins to diminish, cartridge 101 can be easily replaced with an identical cartridge, such that the entire shaft need not be replaced.

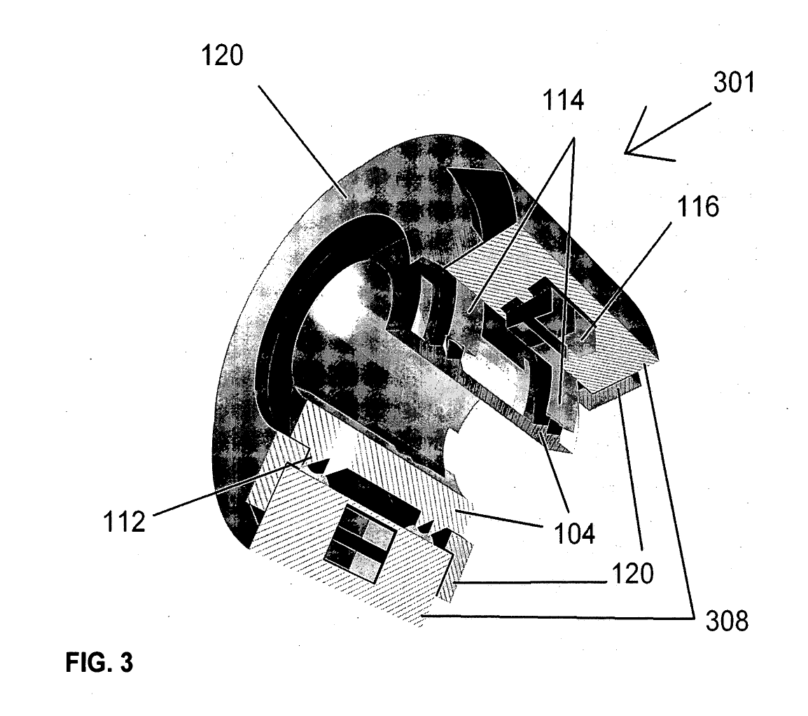

FIG. 3 provides a three-dimensional illustration of another embodiment of a cartridge 301. This embodiment is nearly identical to cartridge 101 except that pole piece 308 does not include the annular channel 118. Instead, magnets 116 are positioned within pole piece 308, for example by being cast (e.g., using powder metallurgy techniques) within pole piece 308. Normally, the thicknesses and dimensions of the various elements are chosen so as to minimize parasitic magnetic currents.

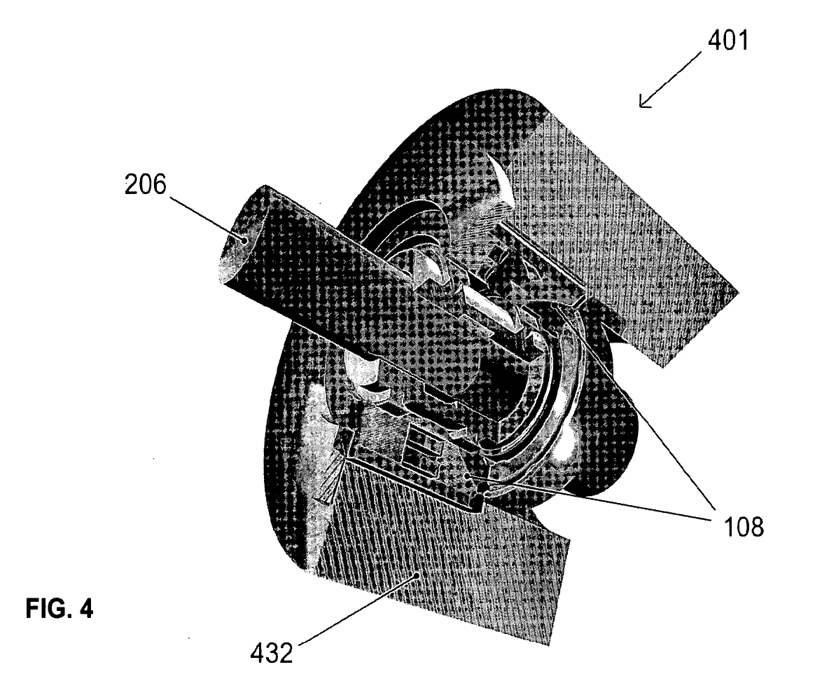

Similarly, FIG. 4 provides a three-dimensional illustration of another embodiment of a cartridge 401, showing shaft 206. Cartridge 401 is also similar to cartridge 101 of FIGS. 1 and 2, except that an housing 432 is shown in this figure. Also, note that in this figure the cartridge is shown in its installed position.

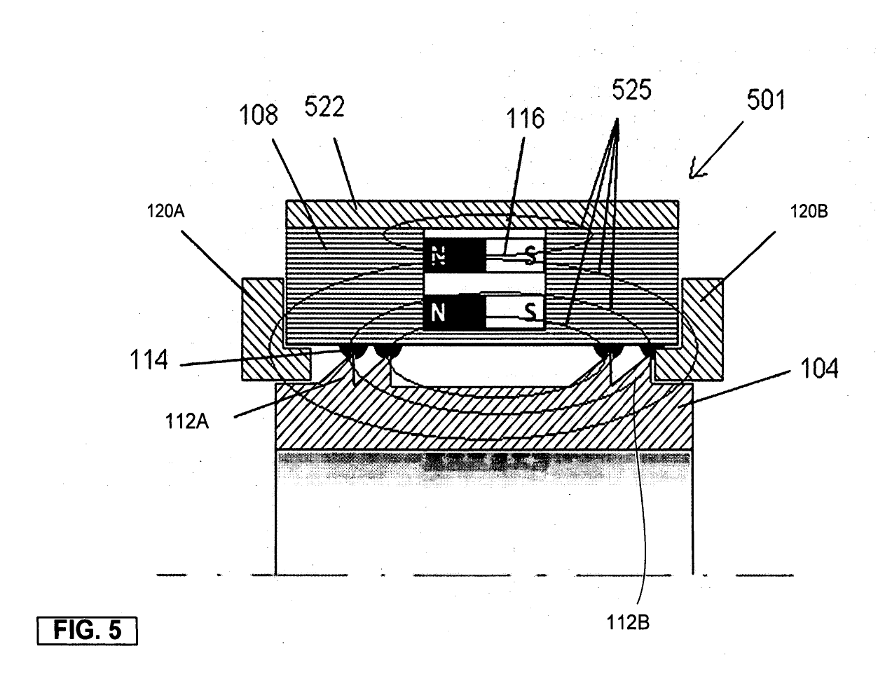

FIG. 5 illustrates another cartridge 501. Cartridge 501 is similar to cartridge 101, except that shell 522 in this embodiment is made of a magnetically conductive material. As such, when in an at-rest position or when being stored, magnetic flux 525 is additionally reduced through magnetic fluid 114 by diverting magnetic flux 525 through shell 522. However, when cartridge 501 is positioned for operation within a casing 224, shell 522 must be removed and a non-magnetically conductive casing 224 must be used, such that the full magnetic flux 525 is concentrated through magnetic fluid 114 during operation to maintain the magneto-fluidic seal.

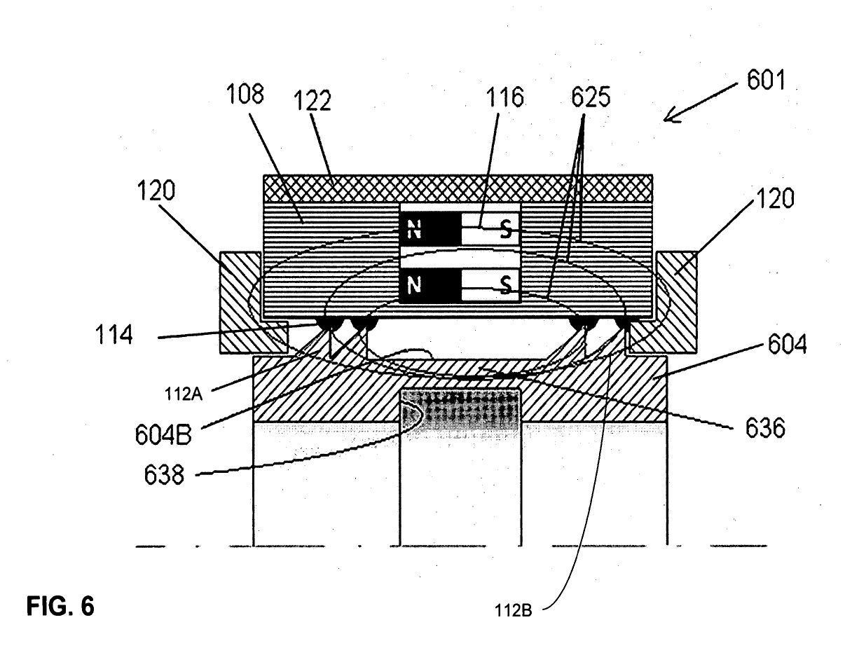

FIG. 6 illustrates another exemplary cartridge 601. Cartridge 601 is similar to cartridge 101 except that shaft sleeve 604 includes a portion 636 of reduced width generally positioned between first set 112A and second set 112B of projections 112. Portion 636 can be formed, for example, by providing a groove 638 on interior surface 604A of shaft sleeve 604, as shown in FIG. 6, or by providing a groove on the exterior surface 604B of shaft sleeve 604. Alternatively, shaft sleeve 604 can be cast particularly to have a portion of reduced width generally in this area. In yet another embodiment, groove 638 can not have right angles, but can be concaved with respect to interior surface 604A of shaft sleeve 604.

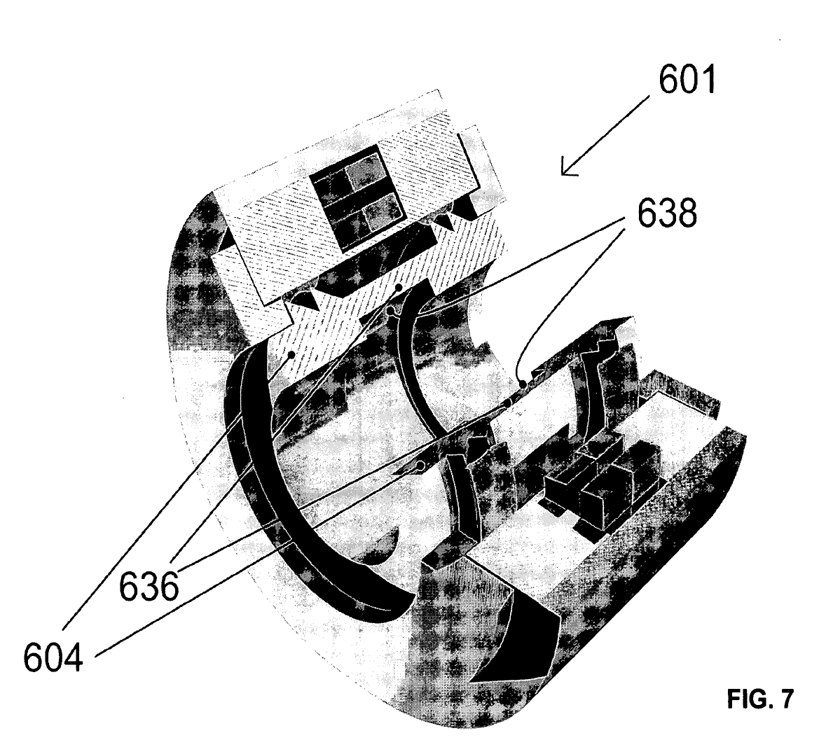

Portion 636 has a reduced cross-sectional area, which further reduces the magnetic flux 625 from magnets 116 through magnetic fluid 114. As shown in FIG. 6, the conductive area for magnetic flux 625 is smaller through shaft sleeve 604, so as to saturate the magnetic flux 625 through portion 636. With this saturation, magnetic resistance increases and the overall magnetic field decreases, limiting the magnetic filed applied to magnetic fluid 114. Similarly, FIG. 7 is a three-dimensional sectional view of cartridge 601 of FIG. 6.

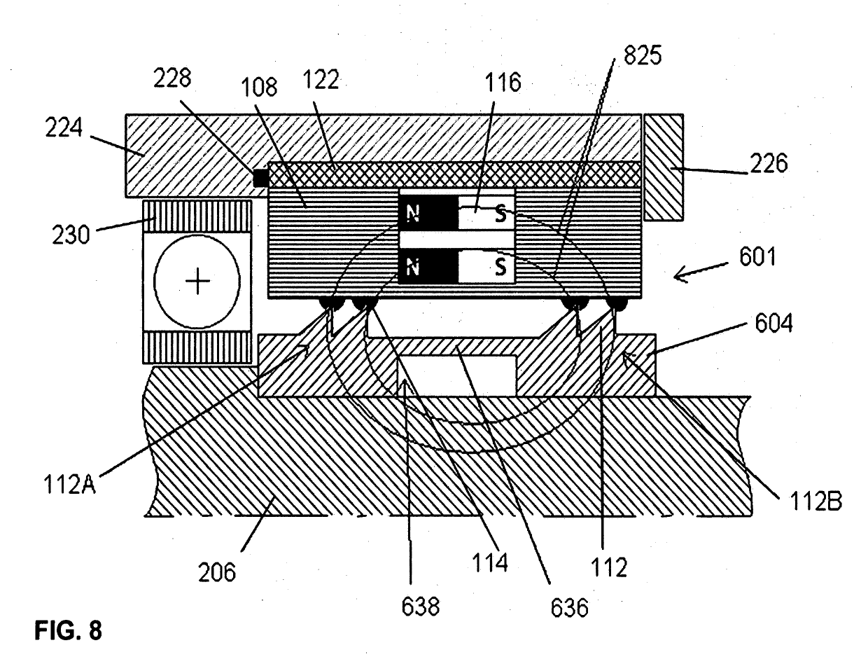

FIG. 8 illustrates cartridge 601 mounted on a shaft 206. When mounted, magnetic flux 825 is again concentrated at magnetic fluid 114 due to the absence of rings 120A, 120B. Also, placing shaft sleeve 604 in contact with a magnetically conductive shaft 206 eliminates the saturation of magnetic flux 825 within portion 636. Instead, the magnetically conductive shaft 206 increases the cross-sectional area through which the magnetic flux 825 can pass, which decreases magnetic resistance and increases the overall magnetic field.

In an alternate embodiment, pole piece 108 rather than shaft sleeve 104 can include a portion of reduced width, such that resistance of the magnetic filed increases in the pole piece 108. In this embodiment, however, a magnetically conductive part must be added when mounted on a shaft 206 to provide additional cross-sectional area and reduce the saturation of the pole piece 108, as shaft 206 does in the embodiment of FIG. 6.

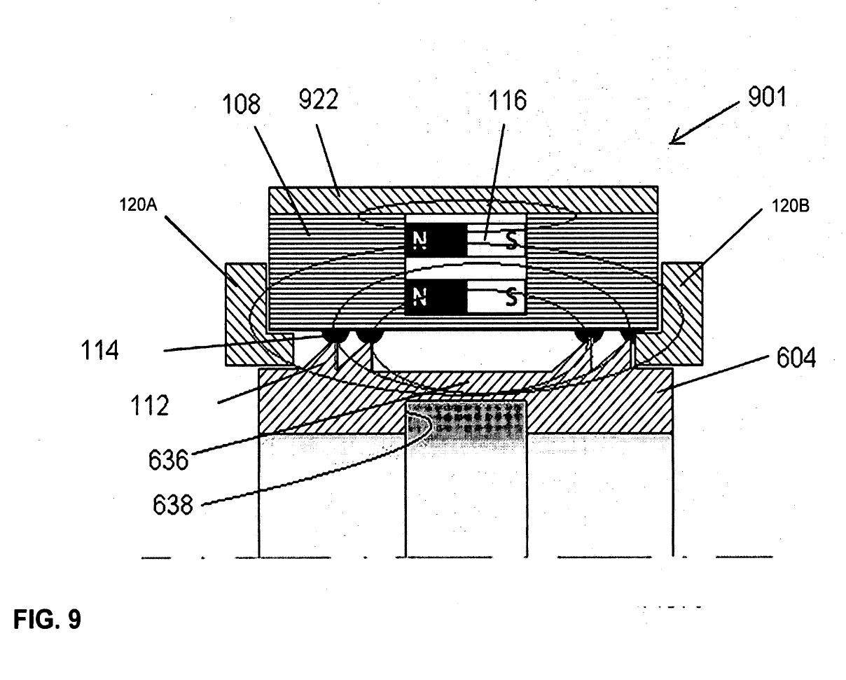

FIG. 9 is a partial sectional view of cartridge 901. Cartridge 901 is similar to cartridge 601, except that shell 922 is a magnetically conductive material, similar to shell 522 of FIG. 5. Shell 922 adds another source for diverting the magnetic field from magnetic fluid 114 during storage of cartridge 901.

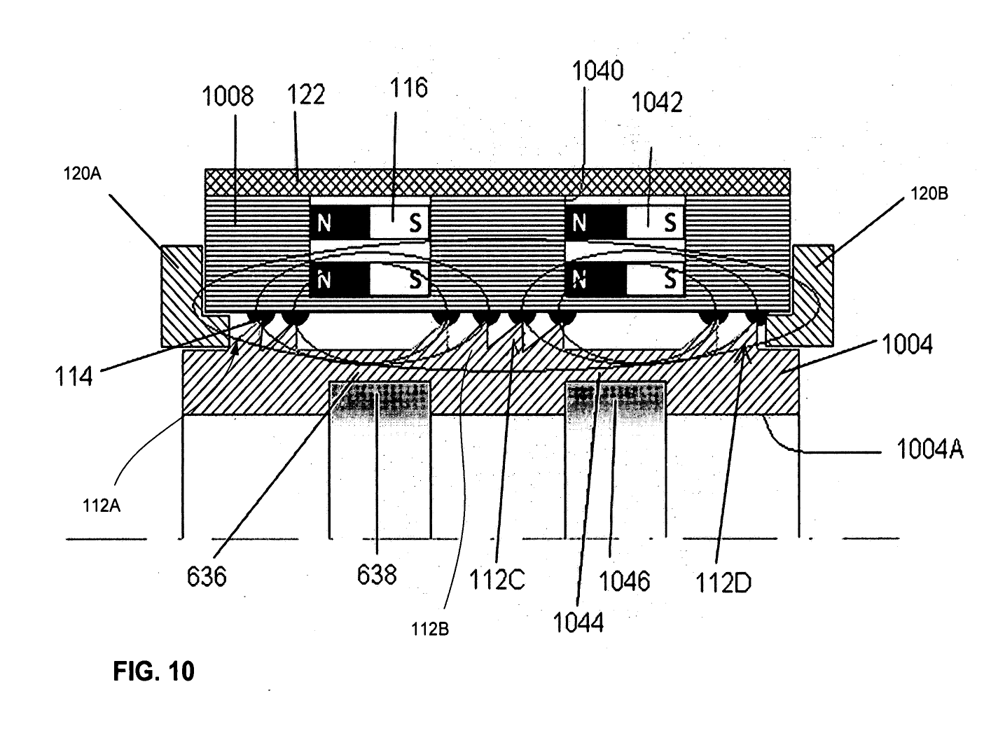

FIG. 10 is a partial sectional view of cartridge 1001. Cartridge 1001 is similar to cartridge 601 except that pole piece 1008 includes an additional groove 1040 into which additional magnets 1042 are placed. The additional groove 1040 and additional magnets 1042 are longitudinally spaced from magnets 116 along a length of pole piece 1008. Shaft sleeve 1004 includes a third set 112C of projections 112 extending towards pole piece 1008 and positioned adjacent a north pole of additional magnets 1042 and a forth set 112D of projections 112 extending towards pole piece 1008 and positioned adjacent a south pole of additional magnets 1042. Shaft sleeve 1004 also includes an additional portion 1044 of reduced width formed by an additional groove 1046 on an interior surface 1004A of shaft sleeve 1004. An increase in the magnetic field generated by the additional magnets 1042 and additional projections 112 increases the critical pressure drop, i.e., the maximum pressure before failure of the magneto-fluidic seal during operation, making the magnetic seal stronger and more reliable.

In alternative embodiments, further additional magnets can be added to the pole piece 108 to increase the magnetic field and/or additional projections can be added to the shaft sleeve 1004.

While specific configurations and arrangements are discussed, it should be understood that this is done for illustrative purposes only, by way of example only, and not limitation. A person skilled in the pertinent art will recognize that other configurations and arrangements can be used without departing from the spirit and scope of the present invention. It will be apparent to a person skilled in the pertinent art that this invention can also be employed in a variety of other applications. Thus, the breadth and scope of the present invention should not be limited by any of the above-described exemplary embodiments, but should be defined only in accordance with the following claims and their equivalents.

What is claimed is:

1. A magneto-fluidic seal cartridge, comprising:
an annular shaft sleeve;
an annular pole piece surrounding the shaft sleeve;
an annular magnet conducting a magnetic field to the pole piece;
a magnetic fluid in a gap between the pole piece and the shaft sleeve; and
a removable ring partially diverting a magnetic flux therethrough during storage,
wherein a magnetic field is concentrated through the magnetic fluid upon removal of the removable ring.

2. The cartridge of claim 1, wherein one of the shaft sleeve and the pole piece includes a plurality of projections extending therefrom into the gap towards the other of the shaft sleeve and the pole piece.

3. The cartridge of claim 2, wherein the magnetic fluid forms fluid rings at the projections.

4. The cartridge of claim 1, further comprising an annular shell surrounding the pole piece.

5. The cartridge of claim 4, wherein the shell is magnetically conductive, and wherein magnetic flux is diverted through the shell during storage.

6. The cartridge of claim 1, wherein at least two sets of magnets are longitudinally spaced along the pole piece and at least four sets of projections extend from one of the shaft sleeve and the pole piece, with one of the at least four sets of projections disposed adjacent each pole of the at least two sets of magnets.

7. The cartridge of claim 1, wherein the annular magnet includes a plurality of segments that collectively form an annulus.

8. The cartridge of claim 1, wherein the annular magnet is formed from a plurality of sub-magnets, each of which is any of cylindrical, flat plate, segmented, and sectional.

9. A magneto-fluidic seal cartridge, comprising:
an annular pole piece having an interior and exterior surface;
an annular magnet generating a magnetic field in the pole piece;
an annular shaft sleeve within the interior surface of the pole piece, the shaft sleeve having an exterior surface and an interior surface and a portion of reduced width between the interior surface and the exterior surface where a magnetic flux from the magnet saturates; and
a magnetic fluid in a gap formed between the pole piece and the shaft sleeve.

10. The cartridge of claim 9, wherein one of the exterior surface of the shaft sleeve and the interior of the pole piece includes a plurality of projections extending therefrom into the gap towards the other of the shaft sleeve and the pole piece.

11. The cartridge of claim 10, wherein the magnetic fluid forms fluid rings at the projection.

12. The cartridge of claim 9, further comprising a removable ring partially diverting a magnetic flux therethrough during storage.

13. The cartridge of claim 9, further comprising an annular shell surrounding the exterior surface of the pole piece.

14. The cartridge of claim 13, wherein the shell is magnetically conductive, and
wherein magnetic flux is diverted through the shell during storage.

15. The cartridge of claim 9, wherein at least two sets of magnets are longitudinally spaced along the pole piece and at least four sets of projections extend from one of the shaft sleeve and the pole piece, with one of the at least four sets of projections disposed adjacent each pole of the at least two sets of magnets.

16. The cartridge of claim 9, wherein the annular magnet includes a plurality of segments that collectively form an annulus.

17. A method for increasing reliability of a magneto-fluidic seal, comprising:
assembling a magneto-fluidic seal cartridge by positioning a magnetic fluid within a gap between a shaft sleeve and a pole piece; and
reducing a magnetic field provided by the magnet in the magnetic fluid cartridge during storage by diverting a portion of the magnetic field.

18. The method of claim 17, wherein the magnetic field is diverted through a removable magnetically conductive ring.

19. The method of claim 17, wherein the magnetic field is diverted through two removable magnetically conductive rings.

20. The method of claim 17, wherein the magnetic field is diverted through a removable magnetically conductive shell.

21. A method for increasing reliability of a magneto-fluidic seal, comprising:
assembling a magneto-fluidic seal cartridge by positioning a magnetic fluid within a gap between a shaft sleeve and a pole piece; and
reducing a magnetic field provided by the magnet in the magnetic fluid cartridge during storage by saturating magnetic flux directed through a portion of reduced width of the shaft sleeve.
